(19) United States
(12) Patent Application Publication
(10) Pub. No.: US 2025/0144594 A1
(43) Pub. Date: May 8, 2025

(54) Treatment of Carbon for Contaminant Removal

(71) Applicant: Ionic Water Technologies, LLC, Hamilton, NJ (US)

(72) Inventors: George W. ADAMSON, Hamilton, NJ (US); David STEIN, Hamilton, NJ (US); Cassidy Rae SCHNEIDER, Hamilton, NJ (US); Victoria KORN, Hamilton, NJ (US)

(21) Appl. No.: 18/720,468

(22) PCT Filed: Dec. 14, 2022
(86) PCT No.: PCT/US2022/081502

§ 371 Date: Jun. 14, 2024

Related U.S. Application Data
(60) Provisional application No. 63/290,074, filed on Dec. 16, 2021.

(51) Int. Cl. B01J 20/20; B01J 20/04; B01J 20/08; B01J 20/28; B01J 20/30; B01J 20/32; C02F 1/28; C02F 101/36

(52) U.S. Cl. CPC B01J 20/20; B01J 20/041; B01J 20/08; B01J 20/28016; B01J 20/3071; B01J 20/3204; B01J 20/3236; B01J 20/3293; C02F 1/283; C02F 2101/36

(57) ABSTRACT

The present invention relates to methods of treating carbon to improve its ability to capture and retain contaminants, and also relates to treated carbon produced by such methods. Treatment of the carbon includes contacting the carbon with (a) a hydroxide and/or a peroxide, and (b) one or more cations selected from Ca²⁺, Mg²⁺, Zn²⁺, Sr²⁺, Al³⁺, B³⁺, and Fe³⁺.

### CROSS-REFERENCE TO RELATED APPLICATIONS

This application claims the benefit of U.S. Provisional Application No. 63/290,074, filed on Dec. 16, 2021, the disclosure of which is incorporated herein by reference in its entirety.

### TECHNICAL FIELD

The present invention relates to methods of treating carbon to improve its ability to capture and retain contaminants, and also relates to treated carbon produced by such methods.

### BACKGROUND

This section provides background information related to the present disclosure and is not necessarily prior art.

Water purification technologies are fundamentally important to everyday life. Contaminants must be removed to purify water to an acceptable level in order for the water to be used as drinking water or for other purposes. Per-and polyfluoroalkyl substances (PFAS) are of particular concern and of particular importance to remove from water. Existing technologies for water purification by removal of contaminants, including PFAS, suffer from issues of efficiency and environmental sustainability. For example, technologies that trap contaminants, such as PFAS, in an ion exchange resin or carbon bed currently require replacement of the bed and disposal of the spent bed to a landfill. Air purification is also another important technology for removing harmful contaminants from air to improve our health and protect the environment. Other liquids and gasses also present needs for purification technologies.

Therefore, while there are existing technologies for removing contaminants, such as for water purification and air purification, a need continues to exist for improved technologies that provide more effective removal of contaminants.

### SUMMARY OF THE INVENTION

In one aspect, disclosed herein is a method of treating carbon to improve its capacity for contaminant removal. The method includes contacting carbon with (a) a hydroxide and/or a peroxide, and (b) one or more cations selected from Ca²⁺, Mg²⁺, Zn²⁺, Sr²⁺, Al³⁺, B³⁺, and Fe³⁺.

In some embodiments, the (a) hydroxide and/or peroxide, and the (b) one or more cations are provided in a single aqueous liquid or in two or more separate aqueous liquids for contacting the carbon. In some embodiments, the (a) hydroxide and/or peroxide comprises sodium hydroxide. In some embodiments, the (a) hydroxide and/or peroxide comprises hydrogen peroxide. And, in some embodiments, the (a) hydroxide and/or peroxide comprises sodium peroxide.

In some embodiments, the (b) one or more cations comprises Ca²⁺. For example, the Ca²⁺ may be provided as calcium hydroxide.

In some embodiments, the (b) one or more cations comprises Al³⁺. For example, the Al³⁺ may be provided as aluminum sulfate, aluminum hydroxide, or sodium aluminate.

In some embodiments, the (a) hydroxide and/or peroxide are provided in a first aqueous liquid: and the (b) one or more cations are provided in a second aqueous liquid. In some embodiments, the first aqueous liquid contacts the one or more ionic contaminants before the second aqueous liquid. In other embodiments, the method comprises contacting the carbon with (a) sodium hydroxide and/or hydrogen peroxide, and (b) calcium hydroxide, aluminum hydroxide, and/or aluminum sulfate.

In some embodiments, the method further comprises rinsing the carbon with an acidic aqueous solution. In some embodiments, the acidic aqueous solution comprises hydrochloric acid, citric acid, sulfuric acid, nitric acid, or any combination thereof. For example, the acidic aqueous solution may comprise hydrochloric acid. In other embodiments, the acidic aqueous solution comprises an acid salt. For example, the acidic aqueous solution may comprise may comprise FeCl₂, FeCl₃, or a combination thereof. And, in some embodiments, the acid rinse is performed after the carbon is contacted with the (a) hydroxide and/or peroxide, and the (b) one or more cations.

In some embodiments, the method further comprises rinsing the carbon with water. In some embodiments, the water is substantially free of additives. And, in some embodiments, the water rinse is performed after the carbon is contacted with the (a) hydroxide and/or peroxide, and the (b) one or more cations, and optionally after the acid rinse.

In some embodiments, the method further comprises contacting the carbon with a surfactant. In some embodiments, the surfactant is selected from fatty acids, sulphones, phosphates, polyethers, sulfates, polyols, or any combination thereof. For example, the surfactant may be selected from fatty acids, sulphones, or phosphates. In some embodiments, the surfactant is selected from sodium dodecyl sulfate (SDS), sorbitan monolaurate, polyethylene glycol (PEG), or any combination thereof. In some embodiments, the surfactant contacts the carbon before the (a) hydroxide and/or peroxide contact the carbon. And, in some embodiments, the surfactant contacts the carbon after the (a) hydroxide and/or peroxide contact the carbon.

In some embodiments, the method further comprises contacting the carbon with an antifreeze agent. For example, the antifreeze agent may be selected from the group consisting of propylene glycol, polypropylene glycol, polyethylene glycol, glycerol, polyvinyl alcohol, carboxymethylcellulose, ribose, sucrose, glucose, rhamnose, xylose, fructose, raffinose, stachyose, low molecular weight hydroxyethyl starches, maltodextrin, cellodextrins, and combinations thereof. In some embodiments, the antifreeze agent comprises glycerol. In some embodiments, the antifreeze agent contacts the carbon before the (a) hydroxide and/or peroxide contact the carbon. And, in some embodiments, the antifreeze agent contacts the carbon after the (a) hydroxide and/or peroxide contact the carbon.

In some embodiments, the carbon is activated carbon. In some embodiments, the activated carbon is granulated activated carbon. In some embodiments, the carbon comprises powder, granules, beads, pellets, cloths, felts, nonwoven fabrics, or composites comprising a material selected from carbon, nitrogen-doped carbon, silicon-doped carbon, boron-doped carbon, charcoal, graphite, biochar, coke, carbon black, or any combination thereof. For example, the carbon comprises activated charcoal powder, granules, pellets, beads, or any combination thereof. And, in some embodiments, the carbon comprises sintered carbon.

In some embodiments, the carbon is dried after being contacted with the (a) hydroxide and/or peroxide, and the (b) one or more cations selected from Ca²⁺, Mg²⁺, Zn²⁺, Sr²⁺, Al³⁺, B³⁺, and Fe³⁺.

In another aspect, disclosed herein is a treated carbon. The treated carbon is produced by a method comprising contacting the carbon with (a) a hydroxide and/or a peroxide, and (b) one or more cations selected from Ca²⁺, Mg²⁺, Zn²⁺, Sr²⁺, Al³⁺, B³⁺, and Fe³⁺.

Other features and advantages of the invention will be apparent from the following detailed description, figures, and from the claims.

### BRIEF DESCRIPTION OF THE DRAWINGS

The following figures are provided by way of example and are not intended to limit the scope of the claimed invention.

FIG. 1 is a plot showing the PFOA concentration in effluent for treated GAC and untreated GAC according to Example 1.

FIG. 2 is a chart showing adsorption isotherms.

### DETAILED DESCRIPTION

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The terms before and after refer to a process step or other event that occurs before or after in time, but which allows for intermediate process steps or events to occur between. Immediately before or immediately after refer to process steps or other events that occur before or after in time without intermediate process steps or events occurring between. In some embodiments, steps described as before or after herein, are performed immediately before or immediately after the step(s) to which they refer. In other embodiments, intermediate steps occur.

The terms, upper, lower, above, beneath, right, left, etc. may be used herein to describe the position of various elements with relation to other elements. These terms represent the position of elements in an example configuration. However, it will be apparent to one skilled in the art that the elements may be rotated in space without departing from the present disclosure and thus, these terms should not be used to limit the scope of the present disclosure.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on.” “directly engaged to.” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “activated carbon” refers to a form of carbon processed to have small pores that increase the available surface area.

As used herein “polyfluoroalkyl ion” refers an ionic compound comprising an alkyl chain with multiple fluoro substitutions, which is optionally further substituted, such as with ether, alcohol, amine (including substituted amine), and carboxylic acid groups.

“Per- and polyfluoroalkyl substance” or “PFAS” includes but is not limited to the following substances: perfluorobutanoic acid, perfluoropentanoic acid, perfluorohexanoic acid (PFHxA), perfluoroheptanoic acid (PFHpA), perfluorooctanoic acid, perfluorononanoic acid (PFNA), perfluorodecanoic acid (PFDA), perfluoroundecanoic acid (PFUnA), perfluorododecanoic acid (PFDoA), perfluorotridecanoic acid, perfluorotetradecanoic acid, perfluorohexadecanoic acid, perfluorooctadecanoic acid, perfluorobutanesulfonic acid, perfluoropentanesulfonic acid, perfluorohexanesulfonic acid (PFHxS), perfluorooctanesulfonic acid, perfluorononanesulfonic acid, perfluorodecanesulfonic acid, perfluorododecanesulfonic acid, perfluorooctanesulfonamide, N-methylperfluoro-1-octanesulfonamide, N-ethylperfluoro-1-octanesulfonamide, 1H,1H,2H,2H-perfluorohexanesulfonic acid (4:2), 1H,1H,2H,2H-perfluorooctanesulfonic acid (6:2), 1H,1H,2H,2H-perfluorodecanesulfonic acid (8:2), 1H,1H,2H,2H-perfluorododecanesulfonic acid (10:2), N-methyl perfluorooctanesulfonamidoacetic acid, N-ethyl perfluorooctanesulfonamidoacetic acid, 2-(N-methylperfluoro-1-octanesulfonamido)-ethanol, 2-(N-ethylperfluoro-1-octanesulfonamido)-ethanol, tetraluoro-2-(heptafluoropropoxy)propanoic acid (“GenX”), 4,8-dioxa-3H-perfluorononanoic acid, 11-chloroeicosafluoro-3-oxaundecane-1-sulfonic acid, or 9-chlorohexadecafluoro-2-oxanone-1-sulfonic acid. PFAS also includes partial fluorinations. The conjugate bases of these acids are examples of polyfluoroalkyl ions. Capturing PFAS includes capturing a conjugate base of a PFAS.

“PFOS” refers to perfluorooctanesulfonic acid. Capturing/releasing PFOS includes capturing/releasing its conjugate base, perfluorooctanesulfonate.

“PFOA” refers to perfluorooctanoic acid. Capturing/releasing PFOA includes capturing/releasing its conjugate base, perfluorooctanoate.

### II. Methods of Treating Carbon

In one aspect, provided herein is a method of treating carbon to improve its capacity for contaminant removal. The method includes contacting carbon with (a) a hydroxide and/or a peroxide, and (b) one or more cations selected from Ca²⁺, Mg²⁺, Zn²⁺, Sr²⁺, Al³⁺, B³⁺, and Fe³⁺.

In some embodiments, the (a) hydroxide and/or peroxide, and the (b) one or more cations are provided in a single aqueous liquid or in two or more separate aqueous liquids for contacting the carbon. For example, the carbon may be placed in a vessel, such as a column, and aqueous liquid(s) may be flowed through the vessel, thereby contacting the carbon with the (a) hydroxide and/or peroxide, and the (b) one or more cations, present in the liquid(s). The carbon may be a carbon bed and may have any shape.

In some embodiments, the (a) hydroxide and/or peroxide comprises sodium hydroxide. In some embodiments, the (a) hydroxide and/or peroxide comprises hydrogen peroxide. In some embodiments, the (a) hydroxide and/or peroxide comprises sodium peroxide.

In some embodiments, the (b) one or more cations comprises Ca²⁺. In some embodiments, the Ca²⁺ is provided as calcium hydroxide. In some embodiments, the Ca²⁺ is provided as calcium chloride. In some embodiments, the (b) one or more cations comprises Al³⁺. In some embodiments, the Al³⁺ is provided as aluminum sulfate. In some embodiments, the Al³⁺ is provided as sodium aluminate. In some embodiments, the Al³⁺ is provided as aluminum hydroxide. In some embodiments, the aluminum hydroxide is used together with sodium hydroxide.

In some embodiments, the (a) hydroxide and/or peroxide are provided in a first aqueous liquid: and the (b) one or more cations are provided in a second aqueous liquid. In some embodiments, the first aqueous liquid contacts the one or more ionic contaminants before the second aqueous liquid. In other embodiments, the second aqueous liquid contacts the one or more ionic contaminants before the first aqueous liquid.

In some embodiments, the second aqueous liquid further comprises an antifreeze agent and a surfactant. The antifreeze agent and the surfactant may be any antifreeze agent and surfactant described herein. In some embodiments, the (a) hydroxide and/or peroxide, and the (b) one or more cations are provided in a single aqueous liquid.

Certain methods according to the present invention include contacting the carbon with (a) sodium hydroxide and/or hydrogen peroxide, and (b) calcium hydroxide, aluminum hydroxide, and/or aluminum sulfate.

Without being bound by theory, it is believed that, among other possible benefits, the (a) hydroxide and/or peroxide facilitate breakdown of biofilm on the carbon. This breakdown of biofilm allows for efficient removal of ionic contaminants from the carbon.

In some embodiments, a method of treating carbon further includes rinsing the carbon with an acidic aqueous solution. In some embodiments, the acidic aqueous solution comprises hydrochloric acid, citric acid, sulfuric acid, nitric acid, or any combination thereof. For example, the acidic aqueous solution may comprise hydrochloric acid. In some embodiments, the acidic aqueous solution comprises an acid salt. For example, the acidic aqueous solution may comprise FeCl₂, FeCl₃, or a combination thereof. In some embodiments, the acid rinse is performed after the carbon is contacted with the (a) hydroxide and/or peroxide, and the (b) one or more cations.

In some embodiments, a method of treating carbon further includes rinsing the carbon with water. In some embodiments, the water is substantially free of additives. In some embodiments, the water rinse is performed after the carbon is contacted with the (a) hydroxide and/or peroxide, and the (b) one or more cations, and optionally after the acid rinse.

In some embodiments, a method of treating carbon further includes contacting the carbon with a surfactant. The surfactant may be an anionic surfactant, a cationic surfactant, an amphoteric surfactant, a nonionic surfactant, or any combination thereof. In some embodiments, the surfactant is selected from fatty acids, sulphones, or phosphates. In some embodiments, the surfactant is selected from fatty acids, sulphones, phosphates, polyethers, sulfates, polyols, or any combination thereof. For example, the surfactant may comprise a fatty acid. In some embodiments, the surfactant comprises a sulphone. In other embodiments, the surfactant comprises a phosphate. In some embodiments, the surfactant comprises a polyether. In some embodiments, the surfactant comprises a sulfate (e.g., sodium dodecyl sulfate (SDS)). In some embodiments, the surfactant comprises a polyol.

Suitable polyethers include, by way of non-limiting example, polyethylene glycol (PEG), polypropylene glycol (PPG), polytetramethylene glycol (PTMG), or any combination thereof. In some embodiments, the polyether comprises PEG. The PEG may have an average molecular weight of less than about 1,000 g/mol, less than about 750 g/mol, less than about 600 g/mol, or less than about 550 g/mol. In some embodiments, the PEG is PEG 500, PEG 400, PEG 300, or any combination thereof. For example, the PEG may be PEG 300.

In some embodiments, the surfactant is selected from sodium dodecyl sulfate (SDS), sorbitan monolaurate, PEG, or any combination thereof.

In some embodiments, the carbon is contacted with the surfactant before the (a) hydroxide and/or peroxide contact the carbon. In some embodiments, the carbon is contacted with the surfactant after the (a) hydroxide and/or peroxide contact the carbon. And, in some embodiments, the carbon is contacted with the surfactant simultaneously with the hydroxide and/or peroxide.

In some embodiments, the carbon is contacted with the surfactant before the (a) hydroxide and/or peroxide, and/or the (b) one or more cations contact the carbon. In other embodiments, the carbon is contacted with the surfactant after the (a) hydroxide and/or peroxide, and/or the (b) one or more cations contact the carbon. And, in some embodiments, the carbon is contacted with the surfactant simultaneously with the (a) hydroxide and/or peroxide, and/or the (b) one or more cations (e.g., the single aqueous liquid or two or more aqueous liquids comprise the surfactant).

In some embodiments, the method of treating carbon further includes contacting the carbon with an antifreeze agent. In some embodiments, the antifreeze agent is selected from the group consisting of propylene glycol, polypropylene glycol, polyethylene glycol, glycerol, polyvinyl alcohol, carboxymethylcellulose, ribose, sucrose, glucose, rhamnose, xylose, fructose, raffinose, stachyose, low molecular weight hydroxyethyl starches, maltodextrin, cellodextrins, and combinations thereof. For example, the antifreeze agent may comprise glycerol.

In some embodiments, the carbon is contacted with the antifreeze agent before the (a) hydroxide and/or peroxide contact the carbon. In some embodiments, the carbon is contacted with the antifreeze agent after the (a) hydroxide and/or peroxide contact the carbon. And, in some embodiments, the carbon is contacted with the antifreeze agent simultaneously with the hydroxide and/or peroxide.

In some embodiments, the carbon is contacted with the antifreeze agent before the (a) hydroxide and/or peroxide, and/or the (b) one or more cations contact the carbon. In other embodiments, the carbon is contacted with the antifreeze agent after the (a) hydroxide and/or peroxide, and/or the (b) one or more cations contact the carbon. And, in some embodiments, the carbon is contacted with the antifreeze agent simultaneously with the (a) hydroxide and/or peroxide, and/or the (b) one or more cations (e.g., the single aqueous liquid or two or more aqueous liquids comprise the antifreeze agent).

In some embodiments, the carbon is dried after being contacted with the (a) hydroxide and/or peroxide, and the (b) one or more cations selected from Ca²⁺, Mg²⁺, Zn²⁺, Sr²⁺, Al³⁺, B³⁺, and Fe³⁺.

The carbon treated according to the present methods may be any carbon material, having any shape and size. The carbon treated according to the present invention is advantageously a carbon suitable for capturing contaminants, such as in water purification or air purification applications. Particular descriptions of the carbon are provided in more detail below.

### III. Treated Carbon

In one aspect, provided herein is a treated carbon. The carbon is treated by a method that includes contacting the carbon with (a) a hydroxide and/or a peroxide, and (b) one or more cations selected from Ca²⁺, Mg²⁺, Zn²⁺, Sr²⁺, Al³⁺, B³⁺, and Fe³⁺. Methods of treating carbon are described according to various embodiments of the present invention. Treated carbon produced according to such various embodiments is also within the scope of the present invention.

The treated carbon may be any carbon material, having any shape and size. In some embodiments, the carbon is activated carbon. Various carbon and activated carbon materials are commercially available and methods for activating carbon are known in the art such as through physical activation (carbonization and activation/oxidation) or chemical activation.

In some embodiments, the activated carbon is granulated activated carbon (GAC). The GAC may be of a mesh size such as 60×80, 8×20, 20×40, 8×30, 4×6, 4×8 or 4×10.

In some embodiments, the carbon comprises powder, granules, beads, pellets, cloths, felts, nonwoven fabrics, or composites comprising a material selected from carbon, nitrogen-doped doped carbon, silicon-doped carbon, boron-doped carbon, charcoal, graphite, biochar, coke, carbon black, or any combination thereof. In some embodiments, the carbon comprises activated charcoal powder, granules, pellets, beads, or any combination thereof. In some embodiments, the carbon comprises sintered carbon. In some embodiments, the carbon is a FILTRASORB® activated carbon bed from Calgon Carbon. In some embodiments, the carbon comprises BLACK PEARLS® 2000 (activated graphite) from Cabot corporation. In some embodiments, the carbon comprises PBX51 (activated graphite) from Cabot corporation. In some embodiments, the carbon comprises F400 granulated activated carbon from Calgon Carbon.

In some embodiments, the carbon is porous. In some embodiments, the carbon has a porosity of from about 30% to about 95%. In some embodiments, the carbon is an activated carbon metal oxide composite. In some embodiments, the carbon is activated graphite. In some embodiments, the carbon is activated charcoal. In some embodiments, the carbon is activated coal. In some embodiments, the carbon is activated coke. In some embodiments, the carbon comprises activated carbon having an average surface area of from about 100 m²/g to about 2000 m²/g. In some embodiments, the carbon comprises activated carbon having an average surface area of from about 2000 m²/g to about 5000 m²/g. In some embodiments, the carbon has a conductivity of from about 0.01 S/cm to about 100 S/cm.

In some embodiments, the carbon bed further comprises a binder dispersed therein. In some embodiments, the binder comprises a wax, a starch, a sugar, a polysaccharide, or any combination thereof. In some embodiments, the wax is a polyethylene wax. In some embodiments, the wax is carnauba wax.

### IV. Uses of Treated Carbon

The treated carbon of the present invention is useful for capturing contaminants. For example, the treated carbon may be used to capture contaminants from a water source or an air source, i.e., in water purification or air purification applications. Other purification applications may also be suitable for the treated carbon.

Applications for the treated carbon of the present invention include removing contaminants (or pollutants) from air or water streams both in the field and in industrial processes such as spill cleanup, groundwater remediation, drinking water filtration, air purification, and VOC capture from painting, dry cleaning, gasoline dispensing, and other processes.

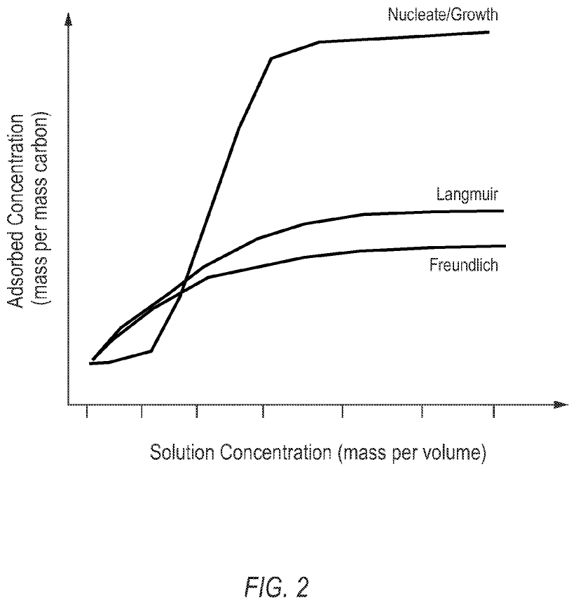

The treated carbon described herein is particularly useful for capturing Per- and polyfluoroalkyl substances (PFAS). For example, it is particularly useful for capturing PFAS from a contaminated water source. The inventors have observed that polyfluorinated compounds do not appear to adsorb onto activated carbon by the traditional isotherm mechanism because they possess an extremely hydrophobic moiety. They appear to follow a nucleation, growth and aggregation mechanism where the hydrophobic moieties aggregate together. These domains appear as micelles adhered to the surface of the activated carbon at high solution concentrations. They are formed when first a few molecules of the perfluoro compounds find a site for adsorption on the activated carbon with some initial affinity. Subsequent perfluoro compounds then preferentially adsorb onto previously adsorbed perfluoro compounds. As the hydrophobic domains grow the effective surface area for adsorption increases until the micelles are too large to remain adhered to the surface of the carbon. This mechanism of adsorption gives an adsorbed amount versus solution concentration curve that looks like a traditional adsorption isotherm, Langmuir or Freundlich, but differing enough to be obvious when fitting experimental data (FIG. 2). The nucleation and growth model provides better fits to experimental data and better predicts the behavior of macroscopic columns. This description of the adsorption mechanism is useful in predicting exhaustion behavior of the activated carbon bed or column when treating natural water sources. There exists confusion in the literature for these compounds since most workers force a fit to an isotherm derived/surface coverage mechanism over small concentration ranges. However, the nucleation and growth model better fits and predicts behavior over many orders of magnitude of concentrations.

Without being bound by theory, the addition of di and trivalent metal salts to PFAS solutions appears to cause stabilization of these micelles. This is because most perfluoro compounds found in water also contain a hydrophilic moiety that usually forms an insoluble salt with the perfluoro compound. The effect of these insoluble salts is to increase the effective hydrophobicity of the perfluoro compound and stabilize both free micelle formation and micelle formation of surfaces. These stabilized micelles can reach tens of microns in size. These insoluble salts can also form with non-fluorinated compounds. These insoluble hydrophobic salts can also be used to stabilize the perfluoro compound micelles. Once these micelles form on the carbon, other organic compounds can become adsorbed into these micelle domains. These insoluble salts of perfluoro compounds, of fatty acids, of sulphonic acids, or of phosphoric acids are useful for pretreating the carbon surface to provide nucleation and stabilization to micelle formation on the surface of the carbon. These may be applied to any micelles of the metal salts and the precipitating compound with the carbon or may be applied to the carbon sequentially. Applying the metal salt first and then the compounds or the compound first and then the metal salt does not matter. Pretreating carbon in this way can boost the adsorption capacity of the carbon for perfluoro compounds found in natural or industrial water sources by up to 70 times (e.g., 2-10×). This pretreatment may also improve the adsorption kinetics, meaning treatment time may also be reduced.

The treatment of carbon according to the present invention may occur prior to a process/application, and thus the treatment may be referred to as “pretreatment.” The pretreatment may be followed by a process to capture contaminants on the carbon, which in turn may be followed by a regeneration process to remove and sequester the contaminants captured on the carbon so that the carbon may be used again for capturing contaminants. Pretreatment according to the present invention may improve the ability of the carbon to capture contaminants, to retain contaminants, and/or to be regenerated.

In some embodiments, the pretreated carbon is useful for removing an ionic contaminant from an aqueous liquid, e.g., for water purification. Examples of ionic contaminants include those having an organic end with an ionic moiety. Specific examples of ionic contaminants include a polyfluoroalkyl ion, a borate, a phosphate, a polyphosphate, a sulfate, an organic acid, a fatty acid, a humic substance, a shortchain PFAS, a water-soluble medication, a detergent, a water-soluble insecticide, a water-soluble fungicide, a water-soluble germicide, and any combination thereof. Another example of an ionic contaminant is a polyfluoroalkyl ion, such as perfluorooctanesulfonate or perfluorooctanoate. Perfluorooctanesulfonate is the conjugate base of perfluorooctanesulfonic acid (PFOS). Perfluorooctanoate is the conjugate base of perfluorooctanoic acid (PFOA). Other polyfluoroalkyl ions are perfluorobutanesulfonate and perfluorobutanoate. Perfluorobutanesulfonate is the conjugate base of perfluorobutanesulfonic acid (PFBS). Perfluorobutanoate is the conjugate base of perfluorobutanoic acid (PFBA).

### V. EXAMPLES

### Example 1: Treatment of Granulated Activated Carbon

Two columns loaded with granulated activated carbon (GAC) were prepared for breakthrough testing. A first column was loaded with untreated GAC (“unpretreated lab F400” or “unpretreated GAC”). A second column was loaded with GAC that was contacted with sodium hydroxide, hydrogen peroxide, aluminum hydroxide, calcium hydroxide, HCl, and DI water, according to the protocol described below (“pretreated lab F400” or “pretreated GAC”).

Materials. Calgon F400 GAC was used in this study. The GAC was 60×80 mesh sieved. A carbon bed, made from the GAC, was installed in a column. The flow rate was set to 2.9 mL/min. Column ID: 1 cm. Bed height: 3-3.2 cm. Bed weight: 1.1-1.15 g.

Pretreated GAC was produced according to the following protocol. Take the econo-column and rinse with 50% ethanol and DI water. Rinse with DI water. Verify that the bottom filter is intact. Fill the column with water and close the bottom valve. Pour 0.5 mm Zirconia/Silica beads to the bottom of the column such that the beads extend 2-3 cm above the bottom filter. Tap gently to ensure the beads are well packed, then open the valve at the column bottom to drain water. Rinse a blender with ethanol and water then fill it with fresh F400 GAC. Blend GAC and wet sieve through ASTM 60 and 80 mesh sieves. Dry 80 mesh sieve to obtain 60×80 mesh fresh F400. Add ˜1.1 g of 60×80 mesh fresh F400 into the column (using ethanol rinsed spatula). The column should be 3 cm tall. Use a syringe to push water up from the bottom of the column, tapping to ensure good packing of the GAC. Continue tapping and flushing with water until air bubbles cease. Push water to 2 cm above the GAC. Add enough 0.5 mm Zirconia/Silica beads to fill up 1-2 cm above the PAC. Tap gently to ensure the beads are well packed. Add a wetted piece of glass wool to the top of the Zirconia/Silica beads and then install the flow adapter to keep the contents of the column in place. Pump DI water through the column and allow F400 to wet for several hours. Pump 250 mL of 1M NaOH fluid through the column at 2.8 mL/min, followed by 250 ml of 12% food grade H₂O₂. Next, pump 2.5 L of 20 g/l Al(OH)₃/10 g/L NaOH fluid through the column at 2.9 mL/min, followed by 2.5 L of a 4 g/L Ca(OH)₂ solution at the same rate. Next, pump 0.5 L of 0. 1M HCl solution through the column at 2.9 mL/min. Finally, pump 2.5 L of DI water through the column at 2.9 mL/min. Repeat the regeneration rinse (Al(OH)₃, NaOH, and Ca(OH)₂), HCl rinse, and DI water rinse, with the volume of DI water in the final rinse increased to 6 L.

Columns of unpretreated GAC and pretreated GAC were pumped with facility water for approximately 20,000 BVs, with samples taken about every 1,000 BVs (approximately 2500 mL).

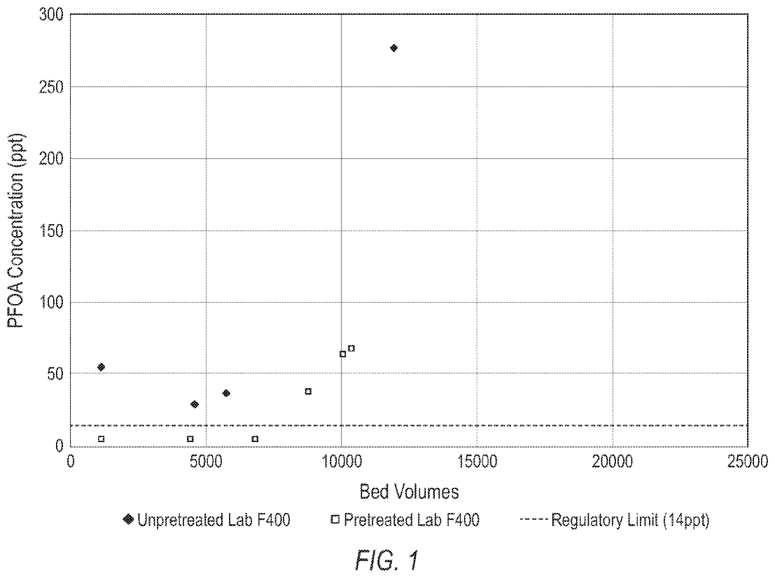

FIG. 1 shows the performance of pretreated F400 GAC column to an unpretreated F400 GAC column, using PFOA as the representative PFAS compound.

The pretreated column breaks through at about 7400 BVs, while the unpretreated column showed breakthrough at 1150 BVs.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of treating carbon to improve its capacity for contaminant removal, the method comprising:
contacting carbon with (a) a hydroxide and/or a peroxide, and (b) one or more cations selected from Ca²⁺, Mg²⁺, Zn²⁺, Sr²⁺, Al³⁺, B³⁺, and Fe³⁺.

2. The method of claim 1, wherein the (a) hydroxide and/or peroxide, and the (b) one or more cations are provided in a single aqueous liquid or in two or more separate aqueous liquids for contacting the carbon.

3. The method of claim 1, wherein the (a) hydroxide and/or peroxide comprises sodium hydroxide.

4. The method of claim 1, wherein the (a) hydroxide and/or peroxide comprises hydrogen peroxide.

5. The method of claim 1, wherein the (a) hydroxide and/or peroxide comprises sodium peroxide.

6. The method of claim 1, wherein the (b) one or more cations comprises Ca²⁺.

7. The method of claim 6, wherein the Ca²⁺ is provided as calcium hydroxide.

8. The method of claim 1, wherein the (b) one or more cations comprises Al³⁺.

9. The method of claim 8, wherein the Al³⁺ is provided as aluminum sulfate, aluminum hydroxide, or sodium aluminate.

10. The method of claim 2, wherein the (a) hydroxide and/or peroxide are provided in a first aqueous liquid; and wherein the (b) one or more cations are provided in a second aqueous liquid.

11. The method of claim 10, wherein the first aqueous liquid contacts the one or more ionic contaminants before the second aqueous liquid.

12. The method of claim 1, comprising contacting the carbon with (a) sodium hydroxide and/or hydrogen peroxide, and (b) calcium hydroxide, aluminum hydroxide, and/or aluminum sulfate.

13. The method of any one of claims 1-12, further comprising rinsing the carbon with an acidic aqueous solution.

14. The method of claim 13, wherein the acidic aqueous solution comprises hydrochloric acid, citric acid, sulfuric acid, nitric acid, or any combination thereof.

15. The method of claim 13, wherein the acidic aqueous solution comprises an acid salt.

16. The method of any one of claims claim 13-15, wherein the acid rinse is performed after the carbon is contacted with the (a) hydroxide and/or peroxide, and the (b) one or more cations.

17. The method of any one of claims 1-16, further comprising rinsing the carbon with water.

18. The method of claim 17, wherein the water is substantially free of additives.

19. The method of claim 17 or 18, wherein the water rinse is performed after the carbon is contacted with the (a) hydroxide and/or peroxide, and the (b) one or more cations, and optionally after the acid rinse.

20. The method of any one of claims 1-19, further comprising contacting the carbon with a surfactant.

21. The method of claim 20, wherein the surfactant is selected from fatty acids, sulphones, phosphates, polyethers, sulfates, polyols, or any combination thereof.

22. The method of claim 21, wherein the surfactant is selected from sodium dodecyl sulfate (SDS), sorbitan monolaurate, polyethylene glycol (PEG), or any combination thereof.

23. The method of any one of claims 20-22, wherein the surfactant contacts the carbon before the (a) hydroxide and/or peroxide contact the carbon.

24. The method of any one of claims 20-22, wherein the surfactant contacts the carbon after the (a) hydroxide and/or peroxide contact the carbon.

25. The method of any one of claims 1-24, further comprising contacting the carbon with an antifreeze agent.

26. The method of claim 25, wherein the antifreeze agent is selected from the group consisting of propylene glycol, polypropylene glycol, polyethylene glycol, glycerol, polyvinyl alcohol, carboxymethylcellulose, ribose, sucrose, glucose, rhamnose, xylose, fructose, raffinose, stachyose, low molecular weight hydroxyethyl starches, maltodextrin, cellodextrins, and combinations thereof.

27. The method of claim 25 or 26, wherein the antifreeze agent contacts the carbon before the (a) hydroxide and/or peroxide contact the carbon.

28. The method of claim 25 or 26, wherein the antifreeze agent contacts the carbon after the (a) hydroxide and/or peroxide contact the carbon.

29. The method of any one of claims 1-28, wherein the carbon is activated carbon.

30. The method of claim 29, wherein the activated carbon is granulated activated carbon.

31. The method of any one of claims 1-28, wherein the carbon comprises powder, granules, beads, pellets, cloths, felts, nonwoven fabrics, or composites comprising a material selected from carbon, nitrogen-doped carbon, silicon-doped carbon, boron-doped carbon, charcoal, graphite, biochar, coke, carbon black, or any combination thereof.

32. The method of claim 31, wherein the carbon comprises activated charcoal powder, granules, pellets, beads, or any combination thereof.

33. The method of any one of claims 1-28, wherein the carbon comprises sintered carbon.

34. The method of any one of claims 1-33, wherein the carbon is dried after being contacted with the (a) hydroxide and/or peroxide, and the (b) one or more cations selected from Ca²⁺, Mg²⁺, Zn²⁺, Sr²⁺, Al³⁺, B³⁺, and Fe³⁺.

35. A treated carbon produced by a method comprising:
contacting the carbon with (a) a hydroxide and/or a peroxide, and (b) one or more cations selected from Ca²⁺, Mg²⁺, Zn²⁺, Sr²⁺, Al³⁺, B³⁺, and Fe³⁺.

36. A treated carbon produced by a method of any one of claims 1-34.
